(19) United States
(12) Patent Application Publication
(10) Pub. No.: US 2011/0171404 A1
(43) Pub. Date: Jul. 14, 2011

(54) Fibre Polymer Composite (Fpc) Material

(76) Inventor: Roland Baker, Gauteng Province (ZA)

(21) Appl. No.: 11/547,658

(22) PCT Filed: Apr. 4, 2005
(86) PCT No.: PCT/IB05/00867

§ 371 Date: May 9, 2008

(30) Foreign Application Priority Data
Apr. 8, 2004 (ZA) 2004/2770

(51) Int. Cl. B32B 3/00; B32B 9/04; B32B 27/10; C08K 7/02; C08L 27/06

(52) U.S. Cl. 428/35.6; 428/411.1; 428/511; 524/13

(57) ABSTRACT

Method of manufacturing a fibrous polymer composite material by compounding an organic fibrous component in particulate form with a mouldable polymeric component to obtain a flowable heated paste. The paste which is formed into an artefact which is caused or allowed to set to provide a solid matrix in which the particles of the fibrous component are dispersed. The method includes, prior to the setting of the polymeric component to form the matrix, the step of colouring the fibrous particles by impregnating them with a colouring material. The invention also provides a fibrous polymer composite material which includes an organic fibrous component in particulate form dispersed in a set polymeric component which is in the form of a matrix. The fibrous particles are coloured by means of a colouring material which is impregnated therein.

THIS INVENTION relates to composite materials known broadly in the art as fibre polymer composite (FPC) materials (also known as cellulose polymer composite (CPC) materials), an important group of which are known as wood polymer composite (WPC) materials. More particularly, the invention relates to a method of manufacturing an FPC material which imparts a desired coloured appearance to the material; and the invention relates to a coloured FPC material.

FPC materials comprise a particulate organic fibrous component, such as a wood sawdust component, dispersed and embedded in a matrix formed by a set polymeric component. Such FPC materials are usually made by compounding a flowable particulate pre-mix including the fibrous component in particulate form and the polymeric component in particulate form, to obtain a flowable heated paste which is formed, typically by extrusion, into an artefact which is caused or allowed to set to provide a product in the form of the set artefact, the artefact comprising a set polymeric matrix in which the particles of the fibrous organic component are dispersed to act as a fibrous reinforcement and as a filler.

The Applicant is aware that such FPC materials have in the past been coloured by adding a master-batch of pigment in particulate or powder form to the flowable pre-mix, the particles of the pigment of the master batch becoming dispersed in the polymeric component of the flowable heated paste during the compounding so that, upon setting of the paste to form the artefact, they are dispersed, together with the particles of the fibrous component, in the matrix provided by the set polymeric component and act to colour the product artefact after the setting of the polymeric component has taken place.

This prior method has the disadvantage that the fibrous particles of the fibrous component remain essentially un-coloured, as essentially no impregnation of the fibrous particles by means of the polymeric component or any pigment particles dispersed in the polymeric component takes place, so that the fibrous particles and the matrix are typically of clearly different colours. This gives the set product a speckled appearance, the product having speckles which are formed by particles which are at or near the surface of the matrix. Furthermore, the fibrous particles in the matrix, particularly at or near its surface, are prone to bleaching when exposed to weathering, especially when exposed to ultra-violet (UV) radiation from sunlight, thereby aggravating and intensifying the unwanted speckled appearance.

A major, if not the major, application of FPC materials is in the extrusion of boards or planks which are used for walkways, flooring, or in particular, decking, in which case they are often extruded with treads to give them a non-slip character, which is particularly useful when they are wet. In use such boards or planks are often exposed to wear by pedestrian traffic, which can wear away surface layers of the matrix overlying fibrous particles, thus exposing the fibrous material of the particles to unprotected UV weathering, which usually aggravates the unwanted speckled appearance and accelerates the intensification thereof, as the particles are typically lighter in colour than the matrix to start with, and are typically bleached further by the weathering.

It will be appreciated that the speckled appearance, and in particular any changes thereto, can render the replacement of worn or damaged artefacts problematic, when these artefacts are sold in accordance with any particular colour code or colour specification. Thus, for example, if a damaged board or plank in a walkway, flooring or decking requires replacement after weathering under the influence of sunlight, replacement thereof by a new board or plank will furthermore also result in an unwanted patchy appearance, as the unweathered replacement board will have a different overall colour and a different speckled appearance from the remaining boards, which differences can be quite stark.

The present invention sets out to address and at least alleviate the problems set forth above.

According to one aspect of the invention there is provided a method of manufacturing a fibrous polymer composite (FPC) material by compounding an organic fibrous component in particulate form with a mouldable polymeric component to obtain a flowable heated paste which is formed into an artefact which is caused or allowed to set to provide a solid matrix in which the particles of the fibrous component are dispersed, the method including, prior to the setting of the polymeric component to form the matrix, the step of colouring the fibrous particles by impregnating them with a colouring material.

Although it is in principle possible, during the compounding, to admix the fibrous component in particulate form with the polymeric component in more or less continuous and at least partially softened flowable paste- or molten form, the compounding of the fibrous component with the polymeric component to obtain the flowable heated paste is conveniently by compounding a particulate pre-mix of the fibrous component in particulate form with the polymeric component in particulate form, the pre-mix comprising both particles of the fibrous component and particles of the polymeric component.

Furthermore, while it is in principle possible to colour the fibrous particles during the compounding and prior to setting of the paste into the artefact, it is expected that colouring of the fibrous particles will usually be carried out prior to the compounding, for example prior to or during the formation of a particulate pre-mix, i.e. prior to dispersing the fibrous particles in the thermoplastic component in flowable paste form.

The invention contemplates using a colouring material or pigment which is so-called colour-fast when impregnated into the fibrous particles, in that the colour of the impregnated particles is resistant and preferably substantially immune to change or fading when exposed to harsh weathering conditions, such as exposure to any of sunlight, water such as sea water, combinations thereof, or the like.

The impregnating of the fibrous particles may be by contacting them with a colouring liquid and causing or allowing the colouring liquid to enter interconnected cavities and/or passages in the interiors of the fibrous particles via surface pores on the particle surfaces. In this case, the contacting of the fibrous particles with the colouring liquid may be by spraying the colouring liquid on the surfaces of the fibrous particles. Naturally, depending on the nature of the liquid colouring material, it can, particularly when contacted with the fibrous particles during the compounding, act also to colour the polymeric component.

The colouring material or pigment used for the spraying is in liquid form to facilitate impregnation and dispersal thereof in the fibrous particles by spraying, the spraying conveniently being by atomising, so that the spraying of the colouring material on the fibrous particle surfaces is of a fine spray in the form of a mist similar to a vapour. When the colouring of the fibrous particles is carried out, as indicated above, prior to the compounding, e.g. prior to or during formation of a particulate pre-mix, the spray, vapour or mist may be directed at the fibrous particles during tumbling of the fibrous particles, either alone or as part of the pre-mix. The tumbling may be by means of a rotary mixer, a ribbon blender or a high-speed mixer.

Prior to the impregnation with the colouring liquid, the fibrous particles may be subject to a sub-atmospheric pressure or vacuum to withdraw gas, vapour and/or liquid from the interconnected interior cavities and/or passages of the fibrous particles via the surface pores, to facilitate the impregnation thereafter with the colouring liquid. The sub-atmospheric pressure to which the particles are subjected may be an absolute pressure in the range 30-70 kPa, typically 40-50 kPa, equivalent to a soft vacuum; and the particles may be subjected to the sub-atmospheric pressure for a period of 30-60 seconds, to promote adequate withdrawal of gas, vapour and/or liquid from the fibrous particles prior to the impregnation with the colouring liquid.

The fibrous particles may be subjected to drying to compensate for unwanted liquid which enters the fibrous particles during the impregnation thereof with the colouring liquid. In this regard it should be borne in mind that, on the one hand, the gas, vapour and/or liquid withdrawn from the particles by the exposure thereof to the sub-atmospheric pressure will usually comprise the gaseous and vapour components of air, and liquid water, the drying likewise usually acting to remove liquid water or water vapour from the fibrous particles and, on the other hand, any colouring liquid used will usually be aqueous or water-based.

The fibrous particles in which the colouring material is impregnated may, prior to the impregnation, have a moisture (water) content of at most 5% by mass, being what is regarded in the art as more or less dry, in which case the method may include a preliminary drying step to reduce the moisture (water) content of the fibrous particles to a desired value, e.g. at most 20% by mass, usually 2-20% and preferably 5-15%. Instead or in addition, the impregnated particles, containing impregnated colouring liquid, may be subjected to drying, again to achieve a desired moisture (water) content, e.g. at most 20% by mass, usually 2-20% and preferably 5-15%. If desired, however, the impregnation of the colouring material may be carried out in principle on fibrous particles which are regarded in the art as more or less moist, having a moisture (water) content of 20-40% by mass.

The impregnation with colouring material may be to a depth of at least 5 μm below the fibrous particle surfaces, typically 5-10 μm, naturally unless the individual particles are so small that they are fully impregnated and saturated with colouring material. In this regard, the Applicant has found that adequate depths of penetration of colouring material into the fibrous particles are achievable using an amount of colouring material sufficient to form at least 1% by mass of the fibrous component, e.g. a fibrous component: colouring material mass ratio on a dry basis of at most 200:1, preferably 30:1-150:1 and typically 100:1.

The fibrous particles may be in the form of granules, which may be more or less cubic or spherical in shape, or they may be more or less elongated, being in the form of fibres or strands. Combinations of said particle shapes for the fibrous particles may also naturally be employed; and the fibrous particles may be in the form of pellets formed by pelletising a particulate fibrous raw material such as sawdust. In whichever form the fibrous component is used, it will have a fibrous and porous internal structure, comprising interconnected interior cavities and/or passages communicating with the particle surfaces via pores in such surfaces.

The compounding of the fibrous component with the polymeric component may be by simultaneous extrusion of the fibrous- and polymeric components. The simultaneous extrusion may be by co-extrusion using a twin-screw extruder to provide the shear necessary for the compounding. Instead, the simultaneous extrusion may be by extrusion of a flowable particulate pre-mix of the fibrous- and polymeric compounds using a single-screw extruder. In each case, if the shear applied by the extrusion and compounding is not enough to heat the polymeric component to a sufficiently paste-like consistency, additional heating may be applied, if desired.

It follows that forming the artefact will typically be by extruding the artefact and causing or allowing the extrusion to cool and set. However, in principle, the invention extends to methods in which forming the artefact is by casting or moulding, e.g. injection moulding, into a mould or die, or machining a set body or lump of the cooled compounded mixture. While the mouldable polymeric component with which the organic fibrous component is compounded will usually be thermoplastic in nature, the invention can, in principle, be extended to polymeric components which are thermosetting in nature. When they are thermoplastic in nature, they may be caused or allowed to set simply by cooling them, whereas, if they are thermosetting in nature, continued heating, after formation into an artefact, can be applied to achieve setting thereof. Both possibilities are in contemplation with regard to the method of the present invention.

The particles of the fibrous component may be cellulose-containing particles selected from materials which are members of the group consisting of flax, rice husks, cane, jute, sisal, hemp, coconut, kenaf, wood (for example from wood pulp), waste paper and suitable mixtures thereof. Typically the fibrous component comprises wood fibre, for example sawdust particles. In a particular embodiment of the invention, the fibrous component comprises particles of sawdust, particularly pine sawdust. If desired, the fibrous component may also include one or more inorganic fibres, such as glass fibres, carbon fibres, ceramic fibres and suitable mixtures of any two or more thereof.

The polymeric component may be selected from members of the group consisting of polyvinyl chlorides, polyethylenes, polypropylenes, nylons (polyamides), polyesters, polystyrenes and suitable mixtures of two or more thereof. Instead of the aforegoing, which are thermoplastic, the polymeric component may be thermosetting, being for example a formaldehyde resin.

The method may include colouring the polymeric component prior to the setting of the paste thereof to form the matrix. The colouring of the fibrous particles and the colouring of the polymeric component may be with matching colours selected to reduce or eliminate any speckled appearance in the set artefact arising from differences in colour between the fibrous particles and the matrix, the matching colours being selected to have the same hue, the same reflectance and the same saturation. Colouring the polymeric component may include admixing a particulate pigment with the polymeric component prior to the compounding, for example by admixing a particulate pigment master batch with a pre-mix comprising the fibrous particles and particles of the polymeric component. Admixing the particulate pigment with the pre-mix may include, prior to formation of the pre-mix, coating particles of the polymeric component with coatings, the coatings being of a colouring material which comprises the particulate pigment dispersed in a matrix which is miscible with the material of the polymeric component during the compounding.

Indeed, if desired, the fibrous particles may be coloured more or less in the same fashion, by coating them with coatings of colouring material prior to the compounding, the coatings, during the compounding, being liquefied sufficiently for the colouring material of the coatings to impregnate and penetrate the porous interiors of the fibrous particles. The coating material will be selected accordingly, to have a sufficiently low viscosity at the compounding temperature for this purpose. In each case the coated particles form so-called colour-pearls, the coating typically being a wax-based coating containing pigment particles. On the one hand, a coating material may be selected to coat the polymeric particles to act as a master batch for colouring the polymeric matrix, and, on the other hand, another coating material may be selected to coat the fibrous particles with coatings which form, at the compounding temperature, the colouring liquid for impregnating the fibrous particles. In each case the coatings can be applied before a pre-mix of the fibrous- and polymeric particles is formed.

In general, the same colouring material or pigment may be used to colour the polymeric component as is used to colour the fibrous component, or a different pigment or colouring material may be used. The pigments or colouring materials may be organic, inorganic or combinations thereof. Furthermore, if desired, any colouring material employed may, particularly if it is liquid, be used as a carrier for introducing additives such as UV inhibiters, heat stabilisers, fire retardants, smoke-retardants, extrusion aids such as lubricants, coupling agents, binders or the like, into the flowable paste. When extrusion is employed to form the artefact, the polymeric component may thus include one or more of the usual lubricants, in the usual proportions employed in the art, for effective extrusion. Such lubricant may be selected from the group consisting of polymer waxes, for example zinc stearate or ethylene bisstearamide of mixtures thereof. For example, the lubricant is a zinc stearate/ethylene bisstearamide mixture, and the lubricant mixture may form 2-6% by mass of the flowable paste, preferably 3-5%. Proprietary products which the Applicant has successfully used as lubricants/coupling agents are those available in South Africa from Sasol Limited under the Trade Marks “Sasolwax H1”, “Sasolwax A28”, “Sasolwax B29” and “Sasolwax Enhance”.

It will be appreciate from the aforegoing that many possibilities exist for colouring the fibrous component in accordance with the method of the present invention, and indeed also for colouring the polymeric component. Thus, coated pigment particles may be added as colouring material to the fibrous particles, or to a pre-mix of the fibrous particles and the polymeric component, which polymeric component may also be in particulate form, the pigment particles being coated with coatings of a material which, at the compounding temperature, melts into a fluid of a sufficiently low viscosity, to impregnate the fibrous particles and carry the pigment particles into the porous interiors thereof, while optionally simultaneously also mixing with the flowable heated paste to colour the polymeric component. Simultaneously colouring the fibrous component and the polymeric component by means of a single colouring step is thus contemplated, particularly if a suitable coating material, which may be a wax or wax-like material, is used to coat the pigment particles.

It should be noted that the method may be carried out continuously or batchwise, as desired; and the compounding may be carried out in a mixer having a heated jacket, heated by a heating fluid such as air, water or oil, or heated by electrical or infrared heating elements. Naturally, when the method is continuous, the colouring material will be added to the compounding step at a rate to match the rate at which the fibrous component and polymeric component are added to the compounding step.

It is further contemplated that high-speed mixers will be useful for the compounding step when the method is carried out batchwise, in particular, whether using colouring liquid or coated pigment particles for the colouring of the fibrous component. Heat generated by such high-speed mixers can assist in melting and reducing the viscosity of the coatings of the pigment particles which are coated by waxy coating materials or the like, as mentioned above. Such high-speed mixers can also be used for colouring the fibrous particles using coated pigment particles whose coatings are melted, prior to the compounding step.

When the fibrous particles are dried to compensate for unwanted liquid impregnated therein during the colouring thereof, excessive drying after the colouring should be avoided, as it can adversely affect the eventual particle colour. Care should thus be taken, if necessary, to limit any increase in moisture content which the fibrous particles undergo during the colouring thereof, to say 0.5-2% by mass, so that the need for extensive subsequent drying is avoided. Naturally, when the fibrous particles are coloured during the compounding step and not prior thereto, heat arising from, or added to, the compounding step can be used to drive off unwanted excess moisture from the paste as vapour or steam, prior to setting of the paste to provide the polymeric matrix.

According to another aspect of the invention there is provided a fibrous polymer composite (FPC) material which includes an organic fibrous component in particulate form dispersed in a set polymeric component which is in the form of a matrix, the fibrous particles being coloured by means of a colouring material which is impregnated therein.

The organic fibrous component and the polymeric component may be present in the FPC material in a fibrous component: polymeric component mass ratio of 1:9-4:1. The fibrous component, and the polymeric component, may each be selected from the possibilities mentioned above in the context of the method. Usually, depending on the natural resources and the fashions prevailing in the countries of manufacture, popular combinations are high- or low density polyethylenes with wood fibre, high- or low density polypropylenes with wood fibre and polyvinyl chloride with wood fibre such as pine sawdust, which the Applicant has used successfully.

Accordingly, in particular, the fibrous component may be in the form of wood particles, the polymeric component being polyvinyl chloride (PVC). The polymeric component may be virgin in nature or recycled, and, depending on the method used to form any artefact, the density of the artefact material will usually be in the range 1.1-1.4 g/cm³, but this density may be reduced by the selective use of a foaming agent in the compounding step, so that the matrix of the product artefact is of a somewhat expanded foam material and contains a desired proportion of small air- or gas bubbles or pockets of a desired size and/or size distribution.

The matrix may be coloured by means of a colouring material dispersed therein; and the colouring material impregnated in the fibrous particles and the colouring material dispersed in the matrix may be selected to provide the particles and the matrix with substantially the same colours, the colours having substantially the same hue, the same reflectance and the same saturation, thereby to promote the absence of any patchy or speckled appearance in the product. More particularly, the same colouring material may be dispersed in the matrix as is impregnated in the fibrous particles, so that the FPC material, before weathering thereof, is substantially free of any speckled appearance arising from the presence of the particles in the matrix.

While the FPC material may be in pelletised form, for example as a pelleted or consolidated particulate material intended for onward sale to a manufacturer for use in making various artefacts, is conveniently in the form of an artefact for sale to an end user. Such artefact may be an extruded profile, and may in particular be in the form of a hollow extruded board or plank. At least one side of the board or plank may be provided, for example by means of longitudinally extending ribs or ridges separated by longitudinally extending grooves or valleys, with a tread giving it a non-slip surface, the board or plank having a hollow interior containing at least one longitudinally extending formation integral with the remainder of the extrusion. This strengthening formation will typically be a rib or partition, which may divide the hollow interior of the board or plank into compartments, and will act to strengthen the board or plank and enhance its resistance to bending.

As indicated above in the context of the method, the product may contain various additives, and these may be present in the usual proportions for their intended purpose, either in the finished product or for use during manufacture thereof.

The composite material may, while hollow boards or planks have been emphasised above, be for use in one or more applications selected from the group consisting of solid boards or planks, decorative mouldings or extrusions, window frames, door frames, window sills, flooring or decking, containers and container flooring, cargo pallets, cladding for the sides of buildings, gutters, fascias, children's playground equipment, outdoor furniture, dog kennels or the like.

Various methods, of dying, known in the art and involving chemicals such as mordants and/or other reactive chemicals, may be used to obtain or promote deeper penetration of colouring material into the fibrous particles.

It should be noted, with regard to both the method and the FPC material of the present invention, that the actual sizes of the fibrous particles are not critical, and can vary over fairly broad ranges, being more or less conventional particle sizes in the art of FPC materials. These particle sizes can vary from as small as 5 μm or less, up to as large as 6 mm or more, usually varying in size over a particle range of 5 μm-6 mm. Particle sizes tend to be kept fairly uniform however, by sieving, either of raw fibrous material or of reground pelletised fibrous material. On the one hand, coarse particles may be used, in the size range of 0.1-3 mm, such as raw or reground pelletised sawdust, or, on the other hand, fine particles may be used, in the size range 5-100 μm, such as wood flour.

The Applicant has found that, when the same colouring liquid is sprayed on or otherwise brought into contact with relatively fine sieved particles, coloured particles are obtained whose colour is somewhat lighter and less intense then that obtained by spraying the same colouring liquid or otherwise bringing it into contact with relatively coarse sieved particles, and larger amounts of colouring liquid are needed to colour fine particles to the same degree as coarse particles. To overcome this problem the Applicant has successfully first admixed a particulate or powder pigment with the fine particles to obtain a dry blend, and has then contacted the blend with a colouring liquid in the form of a liquid suspension or solution of colouring material, which may be organic and/or inorganic in nature. In this case, and indeed in general, so-called supplicants (surfactants or detergents) can be used to reduce surface tension of the colouring liquid, to promote good or high absorption of the colouring liquid into the particles. In this regard a surfactant successfully employed by the Applicant for this purpose has been that available under the Trade Mark “Woodsperse 50”, obtained from Liquid Colours (Proprietary) Limited, Modderfontein, South Africa.

The invention will now be described, by way of non-limiting illustration, with reference to the following worked Examples:

### EXAMPLE 1

An organic fibrous component was employed comprising wood fibre pellets having a diameter of 6 mm and varying lengths in the range 5-30 mm. The pellets were made from pine sawdust having a moisture content of up to 40% by mass, which sawdust was dried in a hot air dryer until the moisture content was 8-9% by mass.

The sawdust was conditioned prior to the pelletising by adding back 2-3% by mass water to obtain a moisture content of 10-12% by mass before densifying the sawdust by means of the pelletising, which took place by forcing the conditioned sawdust through a rotary pelletising die. Heat generated in the pelletising reduced the moisture content of the pellets to 7-8% by mass. The sawdust pellets were then either processed directly or re-ground down to a particle size in the range 0.8-2.1 mm. The moisture content in the particulate sawdust was at all times kept below 10% by mass and in certain cases it was further reduced to 1-2% by mass.

The pellets or re-ground sawdust, as the case may be, were in each case placed in the chamber of a rotary mixer. The rotary mixer was then sealed and operated such that the pellets or particulate sawdust tumbled in the chamber.

Liquid pigment in the form of a colour-fast pigment solution, of dark brown colour, made up of a blend of the red, black and yellow pigments available under the Trade Mark “Multisperse” from Liquid Colours (Proprietary) Limited of 69 Brunton Circle, Founderview, Modderfontein, Gauteng Province, Republic of South Africa, was introduced into the chamber. A mist spray of the pigment solution was directed on to the tumbling pellets or sawdust, as the case may be, in the rotary mixer, via controlled mist spray nozzles protruding into the chamber from the walls thereof. A volume of 6 litres of liquid pigment was sprayed on to 300 kg of pellets or sawdust, as the case may be. In order to achieve the desired impregnation of the pigment in the sawdust, the addition of the pigment to the sawdust was carried out over a period of 15 minutes in total, i.e. 1 minute for every 20 kg of pellets or sawdust, as the case may be. During the impregnation of the pigment into the pellets or sawdust, the moisture content increased by 2-4% by mass. In each case, whether in the form of pellets or re-ground sawdust, sufficient pigment liquid was sprayed to a effect saturation and impregnation to a depth of at least 10 μm below the pellet or particle surface, unless the whole particle was saturated. Pigment consumption was about 100 g of the “Multisperse” for each kg of pellets or sawdust.

A thermoplastic polymeric component in the form of particulate polyvinyl chloride (PVC) of particle size 1-3 μm was then mixed with the particulate colour-fast pellets or sawdust in a hopper to form a pre-mix of colour-fast sawdust-based fibrous component particles and polyvinyl chloride polymeric component particles. The pre-mix was then passed through a twin-screw extruder together with the usual lubricants and other extrusion-enhancement chemicals. The extrusion took place at an elevated temperature of 140-190° C., with the fibrous component drying further, as its moisture content was further decreased. The moisture lost from the fibrous component was vented to prevent the steam formed thereby from entering the extrusion die.

A suitable extrusion die was selected depending on the desired profile required for the composite material artefact to be made. The die selected determined the shape of the artefact profile. As the profile exited the die, it passed through a cooling zone at the downstream end of the die, and then into a calibrator where it was cooled in a fashion which avoided dimensional distortion, followed by final cooling in a water bath. The profile was then cut to length, if necessary, particularly for artefacts in the form of extruded hollow boards or planks, which were extruded with non-slip treads on their surfaces and with internal strengthening ribs in the usual way.

As a variation of this Example it is proposed simply to pass the coloured pre-mix through a pelletising die to extrude pellets of 2-6 mm diameter and a length of 3-6 mm as a raw material for onward sale to users who will extrude profiled artefacts therefrom.

### EXAMPLE 2

In a development or variation of the method described in Example 1, the method of Example 1 was repeated, except that the pine sawdust raw material, after drying to 7-8% by mass moisture, was sieved to obtain a uniform particle size in the range 1-6 mm before pelletising. Similarly, after pelletising or after the re-grinding of pellets, as the case may be, and before the pigment solution was sprayed on it, the fibrous component was again sieved, in the case of pellets to a uniform length of 0.5-3 mm, and in the case of re-ground material to a uniform particle size of 0.25-2 mm.

Furthermore, in addition to colouring the fibrous component as described in Example 1, the PVC pellets were also coloured, by mixing thereof with a pigment master batch of pigment powder. The pigment powder was supplied by Polymer Colour Systems (Proprietary) Limited of 69 Brunton Circle, Founderview, Modderfontein, Gauteng Province, Republic of South Africa under the Trade Mark “Masterbatch VC Range” and was used in an amount of 3 kg pigment powder/150 kg PVC. The PVC and pigment powder were mixed together homogeneously before the coloured fibrous pellets were admixed therewith to form a final homogeneous mixture which was then compounded by mastication in the twin-screw extruder, with heating to drive off moisture prior to the extrusion. As with Example 1, the usual suitable additives such as lubricants for extrusion, an ultra-violet inhibitor, an anti-oxidant and an impact modifier were added to the mixture prior to the compounding.

Results obtained were similar to those of Example 1, except that, the speckled appearance of the product was reduced, the colours of the pigment spray and master batch powder being chosen for this purpose.

The method of imparting a colour to a composite material of the present invention as described in the Examples, can provide a more or less colour-fast composite extrusion which retains its coloured appearance for extended periods of time, despite its being subjected to sunlight and harsh weathering conditions or environments such as water. Thus, the colour-fast nature of the composite product of the present invention can give the product a long-lasting aesthetically pleasing appearance.

1. A method of manufacturing a fibrous polymer composite material by compounding an organic fibrous component in particulate form with a mouldable polymeric component to obtain a flowable heated paste which is formed into an artefact which is caused or allowed to set to provide a solid matrix in which the particles of the fibrous component are dispersed, the method including colouring the polymeric component prior to the setting of the paste and the method being characterized in that it includes,
prior to the setting of the polymeric component to form the matrix, the step of colouring the fibrous particles by impregnating them with a colouring material, the colouring of the fibrous particles and the colouring of the polymeric component being with matching colours selected to reduce any speckled appearance in the set matrix arising from differences in colour between the fibrous particles and the matrix.

2. A method as claimed in claim 1, characterized in that the impregnating of the fibrous particles is by contacting them with a colouring liquid and causing or allowing the colouring liquid to enter interconnected cavities and/or passages in the interiors of the fibrous particles via surface pores on the particle surfaces.

3. A method as claimed in claim 2, characterized in that the contacting of the fibrous particles with the colouring liquid is by spraying the colouring liquid on the surfaces of the fibrous particles.

4. A method as claimed in claim 2, characterized in that, prior to the impregnation with the colouring liquid, the fibrous particles are subjected to a sub-atmospheric pressure or vacuum to withdraw gas, vapour and/or liquid from the interconnected interior cavities and/or passages of the fibrous particles via the surface pores, to facilitate the impregnation thereafter with the colouring liquid.

5. A method as claimed in claim 2, characterized in that the fibrous particles are subjected to drying to compensate for unwanted liquid which enters the fibrous particles during the impregnation thereof with the colouring liquid.

6. A method as claimed in claim 1 characterized in that the impregnation with colouring material is to a depth of at least 5 μm below the fibrous particle surfaces.

7. A method as claimed in claim 1 characterized in that the matching colours are selected to have the same hue, the same reflectance and the same saturation.

8. A method as claimed in claim 1 characterized in that colouring the polymeric component includes admixing a particulate pigment with the pre-mix prior to the compounding.

9. A method as claimed in claim 8, characterized in that admixing the particulate pigment with the pre-mix includes, prior to formation of the pre-mix, coating particles of the polymeric component with coatings, the coatings being of a colouring material which comprises the particulate pigment dispersed in a matrix which is miscible with the material of the polymeric component during the compounding.

10. A fibrous polymer composite material which includes an organic fibrous component in particulate form dispersed in a set polymeric component which is in the form of a matrix, the matrix being coloured by means of a colouring material dispersed therein, and the composite material being in the form of an artefact and being characterized in that
the fibrous particles are coloured by means of a colouring material which is impregnated therein, the colouring material impregnated in the fibrous particles and the colouring material dispersed in the matrix being of matching colours selected to reduce any speckled appearance in the set matrix arising from differences in colour between the fibrous particles and the matrix.

11. A material as claimed in claim 10, characterized in that the organic fibrous component and the polymeric component are present therein in a fibrous component: polymeric component mass ratio of 1:9-4:1.

12. A material as claimed in claim 10, characterized in that the fibrous component is in the form of wood particles, the polymeric component being polyvinyl chloride.

13. A material as claimed in claim 10, characterised in that the colouring material impregnated in the fibrous particles and the colouring material dispersed in the matrix are selected to provide the particles and the matrix with substantially the same colours, the colours having substantially the same hue, the same reflectance and the same saturation.

14. A material as claimed in claim 13, characterized in that the same colouring material is dispersed in the matrix as is impregnated in the fibrous particles, so that the material, before weathering thereof, is substantially free of any speckled appearance arising from the presence of the particles in the matrix.

15. A material as claimed in claim 10, characterized in that it is in pelletised form.

16. A material as claimed in claim 10, characterized in that the artefact is an extruded profile.

17. A material as claimed in claim 16, characterized in that it is in the form of a hollow extruded board or plank.

18. A material as claimed in claim 17, characterized in that at least one side of the board or plank is provided with a tread giving it a non-slip surface, the board or plank having a hollow interior containing at least one longitudinally extending strengthening formation integral with the remainder of the extrusion.
